(19) United States
(12) Patent Application Publication
(10) Pub. No.: US 2018/0012222 A1
(43) Pub. Date: Jan. 11, 2018

(54) PRE-AUTHENTICATION OF MOBILE PAYMENTS

(71) Applicant: INTERNATIONAL BUSINESS MACHINES CORPORATION, ARMONK, NY (US)

(72) Inventors: Shawn L. Berger, Austin, TX (US); Navneet Gupta, Austin, TX (US); Rick A. Hamilton, II, Charlottesville, VA (US); Shawn P. Mullen, Buda, TX (US); Nithya A. Renganathan, Austin, TX (US); Karen M. Siles, Austin, TX (US)

(21) Appl. No.: 15/206,359

(22) Filed: Jul. 11, 2016

(51) Int. Cl. G06Q 20/40; H04W 4/02; G06Q 20/32

(52) U.S. Cl. CPC G06Q 20/401; G06Q 20/327; H04W 4/02

(57) ABSTRACT

An embodiment of the invention may include a method, computer program product and system for transaction authentication. The embodiment may include receiving, by a mobile device from a network server via a wireless access point using a medium-range wireless communication protocol, an indication corresponding to a transaction to execute. The embodiment may include displaying a graphical interface element having an indication of approval to initiate the transaction to execute from a user based on receiving the indication. The embodiment may include authorizing the transaction to execute for a period of time based on receiving the indication of approval to initiate the transaction to execute. The embodiment may include detecting within the period of time, from a point of sale device using a short-range wireless communication protocol, a mobile payment method associated with the transaction to execute. The embodiment may include initiating the transaction based on detecting the mobile payment method.

### BACKGROUND

The present invention relates to mobile payment authentication, and more specifically, to authenticating a mobile payment prior to transaction.

Near field communication (NFC) is a set of communication protocols that enable two electronic devices, one of which is usually a portable device such as a smartphone, to establish communication by bringing them within 4 cm (2 in) of each other. NFC-enabled portable devices can be provided with apps, for example to read electronic tags or make payments when connected to an NFC-compliant apparatus. NFC devices can be used in contactless payment systems, similar to those used in credit cards and electronic ticket smartcards and allow mobile payment to replace/supplement these systems.

### BRIEF SUMMARY

An embodiment of the invention may include a method, computer program product and system for transaction authentication. The embodiment may include receiving, by a mobile device from a network server via a wireless access point using a medium-range wireless communication protocol, an indication corresponding to a transaction to execute. The embodiment may include displaying, by a display on the mobile device, a graphical interface element by which an indication of approval to initiate the transaction to execute from a user based on receiving the indication. The embodiment may include authorizing, by the mobile device, the transaction to execute for a period of time based on receiving the indication of approval to initiate the transaction to execute. The embodiment may include detecting within the period of time, by the mobile device from a point of sale device using a short-range wireless communication protocol, a mobile payment method associated with the transaction to execute. The embodiment may include initiating, by the mobile device, the transaction based on detecting the mobile payment method associated with the transaction to execute.

### BRIEF DESCRIPTION OF THE DRAWINGS

FIG. 1 illustrates a mobile payment authentication system, in accordance with an embodiment of the invention;

FIGS. 2A-2B are a flowchart illustrating the operations of the authentication program of FIG. 1, in accordance with an embodiment of the invention; and

FIG. 3 is a block diagram depicting the hardware components of the mobile payment authentication system of FIG. 1, in accordance with an embodiment of the invention.

### DETAILED DESCRIPTION

Embodiments of the present invention will now be described in detail with reference to the accompanying Figures.

Payments using mobile devices are an increasingly useful mechanism in modern commerce. Such systems allow a user to consolidate all of their payment mechanisms into a single device that already carried by a user, which simplifies the buying experience of the user. In order to create a layer of protection, so that these payment systems will not be abused in instances where a phone is lost or stolen, additional safety features, such as user identification (e.g. passwords, biometrics), are required to complete a transaction. While such measures typically do not unnecessarily delay transactions, in instances where there is a high throughput of people (e.g. subway or rail stations), mechanisms to reduce the authentication delay are necessary to maintain a flow of people past the transaction point.

In an example embodiment, a mechanism to reduce the authentication delay may be accomplished by allowing a user to authenticate the transaction prior to a point of sale (e.g. turnstile). The system may be initiated by local wireless systems at, for example, an entrance to a train station which communicate to a mobile device the nature of the upcoming transaction. This may allow the user to authenticate the specific transaction that they want to occur prior to reaching the point of sale.

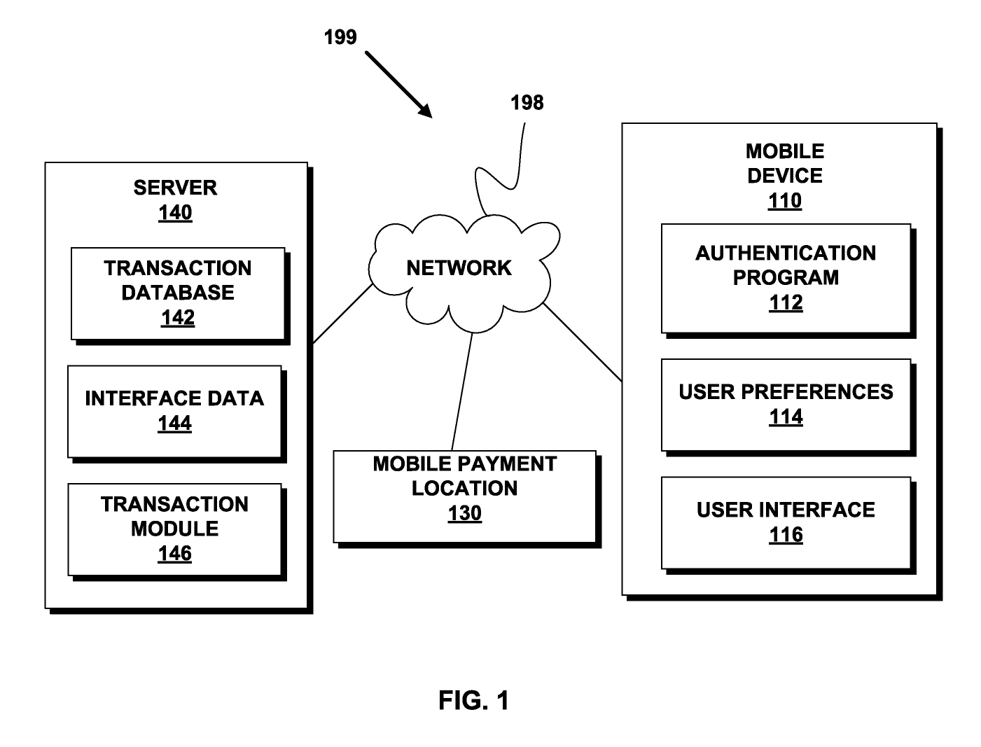

FIG. 1 illustrates pre-authorization system 199, in accordance with an embodiment of the invention. In an example embodiment, pre-authorization system 199 includes a mobile device 110 and a server 140 interconnected via a network 198.

Network 198 may include, for example, wired, wireless or fiber optic connections. In other embodiments, network 198 may be implemented as an intranet, a local area network (LAN), or a wide area network (WAN). In general, network 198 can be any combination of connections and protocols that will support communications between the mobile device 110, mobile payment location 130 and the server 140. In an example embodiment, network 198 forming the connection between the mobile device 110 and the server 140 represents wireless access point using, for example, a low energy wireless technology(such as Bluetooth® Low Energy), Bluetooth®, Wi-Fi (using, for example, an infrastructure mode) or other medium-range wireless communication protocols for communications with mobile device 110, and may be routed to server 140 using a wired or wireless connection (Bluetooth ® is a registered trademark owned by Bluetooth SIG, Inc.). In an example embodiment network 198 forming the connection between the mobile device 110 and the mobile payment location 130 may be a short-range communication protocol, such as RFID or NFC.

Mobile payment location 130 may be any point of sale terminal that is capable of wireles sly communicating with mobile device 110 using a short-range communication protocol, such as RFID or NFC. Mobile payment location 130 may communicate the received information to transaction module 146, located on server 140. In some embodiments, multiple mobile payment locations 130 may be employed, marking the beginning and end of a transaction (e.g. entrance and exits of metro stops).

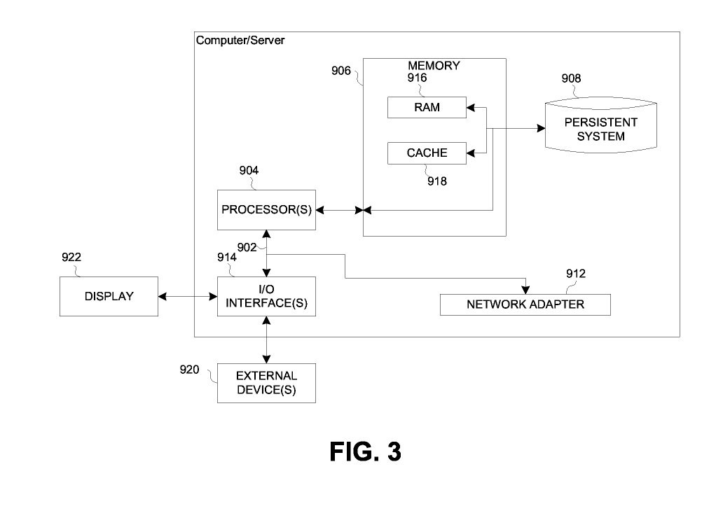

Server 140 may include a transaction database 142, interface data 144 and transaction module 146. Server 140 may be a desktop computer, a notebook, a laptop computer, a tablet computer, a handheld device, a smart-phone, a thin client, or any other electronic device or computing system capable of receiving and sending data to and from other computing devices such as mobile device 110 via network 198. Although not shown, optionally, server 140 can comprise a cluster of web servers executing the same software to collectively process the requests, and resulting transactions, for multiple mobile devices in range of the wireless signal of the network 198. Server 140 is described in more detail with reference to FIG. 3.

Transaction database 142 may be a database cataloging transactions, according to the embodiments of the invention. Transaction database 142 may catalogue information received from mobile payment location 130 such as a user number (e.g. credit card number) associated with the mobile device, as well as details relating to the charge incurred, so that such charges may be relayed to a financial institution of the user to complete the transaction. Additionally, transaction database 142 may contain information pertaining to the timing of the transaction such as, for example, the time between pre-approval and completion of the transaction, as well as the location of the mobile device 110 when the pre-approval occurred.

Interface data 144 may include information to be transmitted to the mobile device 110 which may form the basis of, or assist in, a transaction. In one embodiment, interface data 144 may include a price and description, of the transaction that is going to occur. In another embodiment, interface data 144 may include a list of options for a user to select, as well as any associated prices. In yet another embodiment, interface data 144 may include data corresponding to aspects of the purchase, such as delays, wait times from where a user is standing, or any other relevant information. In one embodiment, the wait times may be based on real world data from users (e.g. modeling user location versus time until transaction for different times of the day), and may be used to calculate how long an approved transaction should be valid.

Transaction module 146 may work with authentication program 112 to process a transaction using typical protocols and methods for processing mobile transactions. Transaction module 146 may receive a unique identifier from the authentication program, using a short-range wireless connection established between the mobile device 110 and the mobile payment location 130, and transmitted to the server 140 via network 198. The unique identifier may be, for example, a credit card number, a device account number, or other means of identifying the user. Once transaction module 146 receives the unique identifier, it completes the transaction by sending the unique identifier, as well as the transaction cost and other relevant information contained in transaction database 142, to a third party, such as a financial institution.

Mobile device 110 includes authentication program 112, preferences 114 and user interface 116. In the example embodiment, mobile device 110 is a smart phone, a tablet computer, a handheld device, a wearable device, an implantable device, or any other electronic device or computing system capable of receiving data from server 140 via network 198 (using, for example, BLE), containing a mobile transaction system, such as a NFC, and capable of operating a graphical user interface to interface with a user. Mobile device 110 is described in more detail with reference to FIG. 3.

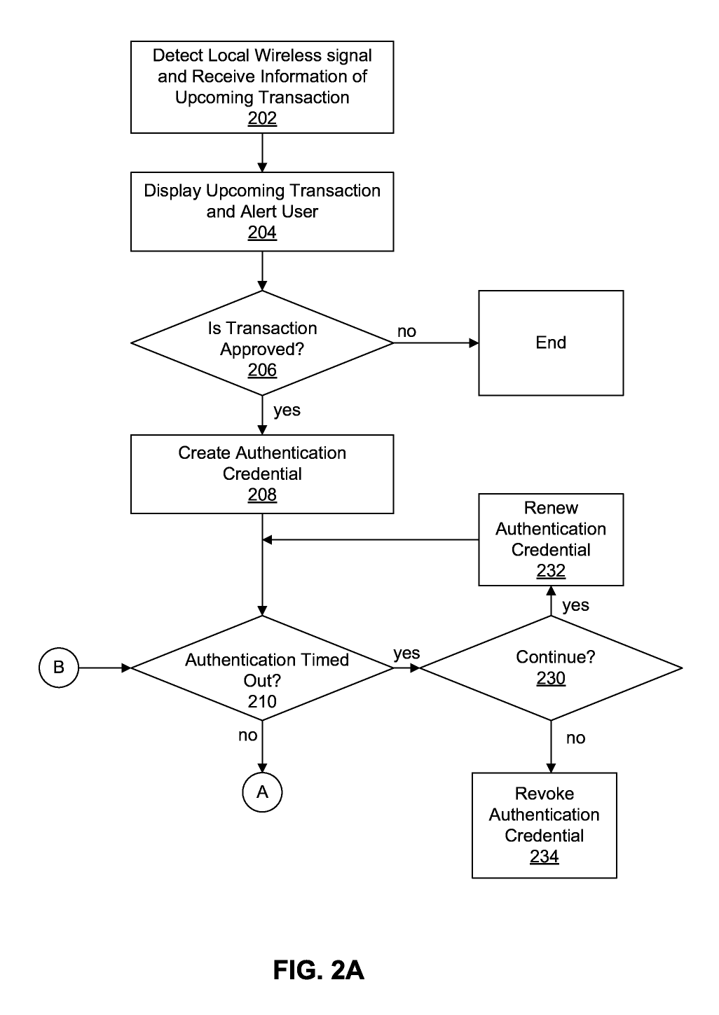

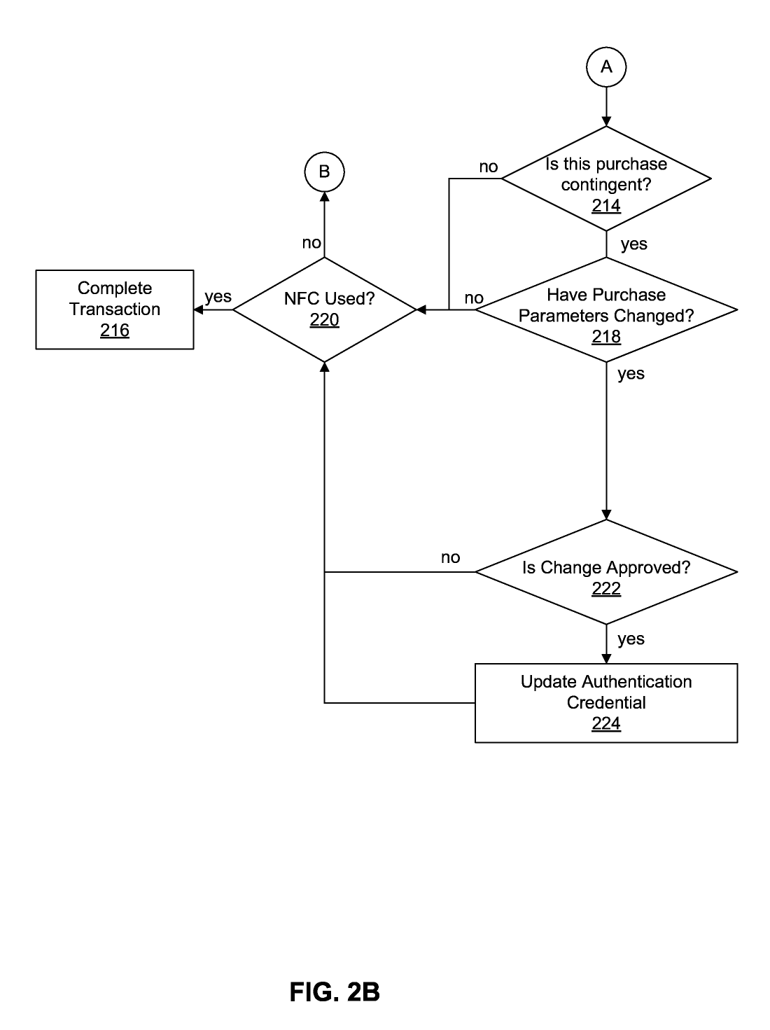

In the example embodiment, preferences 114 may contain information detailing user defined values for use in the operation authentication program 112. In the example embodiment, preferences 114 may include time that an authorization is active, frequent or preferred choices for specific NFC purchases, or other relevant parameters. Preferences 114 are described in further detail below with regard to FIGS. 2A and 2B.

User interface 116 includes components used to relay information to a user, as well as receive input from a user and transmit the input to an application residing on mobile device 110. In an example embodiment, user interface 116 uses a combination of technologies and devices, such as device drivers, to provide a platform to enable users of mobile device 110 to interact with authentication program 112. In the example embodiment, user interface 116 receives input, such as tactile input received from a physical input device, such as a touch screen, via a device driver that corresponds to the physical input device.

Authentication program 112 is a software application or configuration in a software application capable of receiving an authorization for a mobile payment from a user, and completing the subsequent mobile transaction using, for example, NFC. Authentication program 112 detects a signal from a short range wireless transmission, where the wireless transmission is associated with a specific transaction. The authentication program 112 displays an authentication message to a user, who may either pre-authenticate the transaction, or deny the transaction. In instances where the user pre-authenticates the transaction, authentication program 112 is capable of completing the transaction using a mobile payment mechanism, such as NFC, for a period of time. While authentication program 112 is depicted as located on the mobile device 110, embodiments where authentication program 112 is located on server 140 are contemplated. The operations and functions of authentication program 112 are described in further detail below with regard to FIGS. 2A and 2B.

FIGS. 2A and 2B is a flow chart illustrating a method for the authentication program 112. Referring to step 202, authentication program 112 detects an indication of an upcoming transaction, such as a local wireless signal. The local wireless signal may be a BLE, or wifi, signal mounted on or near a payment system. Detection of the wireless signal may be performed using Bluetooth® or wireless devices located on the mobile device 110. Additionally, the local wireless signal may contain information detailing an upcoming mobile transaction, such as cost of the transaction, options to select for the transaction, prospective wait times to the transaction point, etc.

Referring to step 204, authentication program 112 displays or relays information pertaining to an upcoming mobile transaction to a user of the mobile device 110. The information may be displayed visually, or audibly, via user interface 116, to communicate transaction options to the user. Additionally, relaying information to the user may include alerting the user of the upcoming transaction using, for example, audio or tactile notifications to get the attention of the user. In an example embodiment, the user interface 116 may display a graphical interface element to the user, which the user may interact with to assert approval. In another embodiment, the user interface 116 may transmit audio to the user detailing the transaction, which the user may select using an audio response. In yet another embodiment, a defined tactile notification may be used to detail the upcoming transaction (e.g. short-long-short-long-short-long).

Referring to step 206, authentication program 112 receives input from a user and determines if a specific mobile transaction was approved. Authentication program 112 may be received by input through the user interface 116, and the input may correspond to the selection of a specific transaction type (e.g. the final destination on a metro stop), or available discounts. Additionally, authentication may be a biometric or passcode related affirmation of a purchase, as defined by the mobile device 110 software or preferences.

Referring to step 208, authentication program 112 creates transaction credentials for the approved transaction. The transaction credential may act as an authorization for a point of sale transaction using a mobile device. The transaction credential may be an authorization for a specific amount to be charged to a user's account, for a specific transaction. The transaction credential may also include a duration, or an expiration time, of the credential. In an example embodiment, the duration may be based on user selected criterion contained in preferences 114.

In another embodiment, the duration of time may be determined based on historical trends or models based on information contained in transaction database 142. The model may correlate a location of the pre-authorization with the time required for the user to complete the transaction. A typical time for the transaction may be determined inputting the user's current location of the pre-authorization into the model, and receiving a time based on the model created from the historical data. The duration of time of the credential may be the typical time for transaction, with an additional time buffer (e.g. an additional 20% time added) to allow for certain atypical behavior.

Referring to step 210, authentication program 112 determines if the transaction credential has timed out. The transaction credential times out if the current time is past the expiration time, or alternatively if the duration of the credential has been exceeded. If the transaction credential has not timed out, authentication program 112 proceeds to step 214. If the transaction credential has timed out, authentication program 112 proceeds to step 230.

Referring to step 214, authentication program 112 determines if the mobile payment is contingent on a specific endpoint for the transaction to be valid. A contingent purchase may be a purchase where the cost of the purchase changes depending on actions occurring between the initiation and conclusion of the purchase (e.g. change in duration of travel, or number of stops traveled). In one example, a contingent purchase may be a purchase on a commuter rail, where the cost changes depending on where the user gets off. If the payment is contingent, authentication program 112 proceeds to step 218. If the payment is not contingent, authentication program 112 proceeds to step 216.

Referring to step 218, authentication program 112 determines if the purchase parameters have changed. A change in the purchase parameters includes any action in which there would be a change in the purchase (e.g. the originally authorized purchase would not be valid). The change in purchase parameters may be determined when, for example, the mobile device 110 is not on an expected path to complete the previously authenticated transaction (e.g. not a direct route from the first transaction point to the last transaction point). In an example embodiment, this may occur when a user either misses the stop they were supposed to get off at (and the original transaction was dependent on the stop), or alternatively in an instance where a user is waiting for a different train the required train. This may be determined using location device in the phone, such as GPS, or alternatively may be used by contacting medium-range wireless signals at set locations (e.g. wifi or Bluetooth®). If the purchase parameters have changed, authentication program 112 proceeds to step 222. If the purchase parameters have not changed, authentication program 112 proceeds to step 220.

Referring to step 220, authentication program 112 determines if the mobile payment method has been detected using a short-range wireless protocol. Detection of the mobile payment method may occur when a mobile device is brought in the vicinity of a first transaction point (e.g. mobile payment location 130), and the transaction point receives a communication from the mobile device detailing the credentials of the device. Additionally, the duration of time between pre-authentication and mobile payment may be sent to server 140 and stored in transaction database 142. If the mobile payment method has been detected, authentication program 112 proceeds to step 216. If the mobile payment method has not been detected, authentication program 112 proceeds to step 210.

Referring to step 216, authentication program 112 completes the authorized transaction. Completion of the authorized transaction may be completed by transmitting identifying information from the authentication program 112 to the transaction module 132. Completion of the authorized transaction may include recording the identifying information associated with the mobile device 110, as well as the cost of the transaction, in a ledger such as transaction database 142. Additionally, the duration of time between pre-authentication and mobile payment may be sent to server 140 and stored in transaction database 142. Further, transaction database 142 may communicate characteristics of the transaction to other institutions necessary to complete the transactions (e.g. financial institution of the user).

Referring to step 222, authentication program 112 alerts the user of the possible transaction change, and asks for approval of the change. The user is notified of this change (or possible change) and is asked to approve the change. In one embodiment, this may be an alert that the user is not near the correct train line to correct the transaction. In another embodiment, this alert may be that the user has missed a specific station. If the user approves the changed parameters (e.g. the user agrees to the change in course), the authentication program 112 proceeds to step 224. If the user does not approve the changed parameters (e.g. user will return to previous route), authentication program 112 proceeds to step 220.

Referring to step 224, authentication program 112 updates the authentication credentials to reflect the changed purchase. The credentials are updated to complete the newly authorized transaction when the NFC from the mobile device 110 is in the vicinity of a final transaction point.

Referring to step 230, authentication program 112 displays a notification to the user that the transaction credential has expired, and receives input from the user whether the transaction credential should be extended. The information may be displayed visually, or audibly, via user interface 116, to communicate transaction options to the user. If the transaction credential is selected to be extended, authentication program 112 proceeds to step 222. If the transaction credential is not selected to be extended, authentication program 112 proceeds to step 222.

Referring to step 232, authentication program 112 renews the transaction credential. Renewal of the transaction credential increases the time to complete the transaction. Following renewal of the transaction credential, authentication program 112 proceeds to step 210.

Referring to step 234, authentication program 112 revokes the transaction credential. The revocation of the transaction credential disables the previously created pre-transaction approval, and would require restarting of the authentication program 112 to complete the transaction.

FIG. 3 depicts a block diagram of components of mobile device 110, mobile payment location 130 and server 140, in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

Mobile device 110, mobile payment location 130 and server 140 include communications fabric 902, which provides communications between computer processor(s) 904, memory 906, persistent storage 908, communications unit 912, and input/output (I/O) interface(s) 914. Communications fabric 902 can be implemented with any architecture designed for passing data and/or control information between processors (such as microprocessors, communications and network processors, etc.), system memory, peripheral devices, and any other hardware components within a system. For example, communications fabric 902 can be implemented with one or more buses.

Memory 906 and persistent storage 908 are computer-readable storage media. In this embodiment, memory 906 includes random access memory (RAM) 916 and cache memory 918. In general, memory 906 can include any suitable volatile or non-volatile computer-readable storage media.

The programs authentication program 112, user preferences 114, and user interface 116 in mobile device 110; and transaction database 142, interface data 144 and transaction module 146 in server 140 are stored in persistent storage 908 for execution by one or more of the respective computer processors 904 via one or more memories of memory 906. In this embodiment, persistent storage 908 includes a magnetic hard disk drive. Alternatively, or in addition to a magnetic hard disk drive, persistent storage 908 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 908 may also be removable. For example, a removable hard drive may be used for persistent storage 908. Other examples include optical and magnetic disks, thumb drives, and smart cards that are inserted into a drive for transfer onto another computer-readable storage medium that is also part of persistent storage 908.

Communications unit 912, in these examples, provides for communications with other data processing systems or devices. In these examples, communications unit 912 includes one or more network interface cards. Communications unit 912 may provide communications through the use of either or both physical and wireless communications links. The programs authentication program 112, user preferences 114, and user interface 116 in mobile device 110; and transaction database 142, interface data 144 and transaction module 146 in server 140 may be downloaded to persistent storage 908 through communications unit 912.

I/O interface(s) 914 allows for input and output of data with other devices that may be connected to mobile device 110, mobile payment location 130 and server 140. For example, I/O interface 914 may provide a connection to external devices 920 such as a keyboard, keypad, a touch screen, and/or some other suitable input device. External devices 920 can also include portable computer-readable storage media such as, for example, thumb drives, portable optical or magnetic disks, and memory cards. Software and data used to practice embodiments of the present invention, e.g., The programs authentication program 112, user preferences 114, and user interface 116 in mobile device 110; and transaction database 142, interface data 144 and transaction module 146 in server 140, can be stored on such portable computer-readable storage media and can be loaded onto persistent storage 908 via I/O interface(s) 914. I/O interface(s) 914 can also connect to a display 922.

Display 922 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While steps of the disclosed method and components of the disclosed systems and environments have been sequentially or serially identified using numbers and letters, such numbering or lettering is not an indication that such steps must be performed in the order recited, and is merely provided to facilitate clear referencing of the method's steps. Furthermore, steps of the method may be performed in parallel to perform their described functionality.

What is claimed is:

1. A method for transaction authentication, the method comprising:
receiving, by a mobile device from a network server via a wireless access point using a medium-range wireless communication protocol, an indication corresponding to a transaction to execute;
based on receiving the indication, displaying, by a display on the mobile device, a graphical interface element by which an indication of approval to initiate the transaction to execute from a user;
based on receiving the indication of approval to initiate the transaction to execute, authorizing, by the mobile device, the transaction to execute for a period of time;
detecting within the period of time, by the mobile device from a point of sale device using a short-range wireless communication protocol, a mobile payment method associated with the transaction to execute; and
based on detecting the mobile payment method associated with the transaction to execute, initiating, by the mobile device, the transaction.

2. The method of claim 1, further comprising:
based on determining that the period of time has expired, requesting, by the mobile device, a renewal of the transaction to execute from the user;
based on receiving the renewal of the transaction to execute from the user, extending, by the mobile device, the period of time.

3. The method of claim 1, further comprising:
determining, by the mobile device, a location of the user;
determining, by the mobile device, the location of the user is not following a transaction path, wherein the transaction path is a path from a location of the indication corresponding to the transaction to execute to the mobile payment method; and
notifying, by the mobile device, the user of that the location of the user is not following the transaction path.

4. The method of claim 3, further comprising:
based on determining the location of the user is not following the transaction path, requesting, by the mobile device, approval from a user for a modification to the transaction to execute; and
receiving, by the mobile device, approval from the user.

5. The method of claim 1, wherein the medium-range wireless communication protocol comprises one or more of: wi-fi and a low energy wireless protocol.

6. The method of claim 1, wherein receiving approval from the user comprises authentication by the user.

7. The method of claim 1, wherein the short-range wireless communication protocol is a near field communication protocol.

8. A computer program product for transaction authentication, the computer program product comprising:
one or more computer-readable storage devices and program instructions stored on at least one of the one or more tangible storage devices, the program instructions comprising:
program instructions to receive an indication corresponding to a transaction to execute, wherein the indication is received from a network server via a wireless access point using a medium-range wireless communication protocol;
based on receiving the indication, program instructions to request an indication of approval to initiate the transaction to execute from a user using a graphical interface element on a display;
based on receiving the indication of approval to execute the transaction to execute, program instructions to authorize the transaction to execute for a period of time;
program instructions to detect within a period of time a mobile payment method associated with the transaction to execute, wherein the mobile payment method is detected from a point of sale device using a short-range wireless communication protocol; and
based on detecting the mobile payment method associated with the transaction to execute, program instructions to initiate the transaction.

9. The computer program product of claim 8, further comprising:
based on determining that the period of time has expired, program instructions to request a renewal of the transaction to execute from the user; and
based on receiving the renewal of the transaction to execute from the user, program instructions to extend the period of time.

10. The computer program product of claim 8, further comprising:
program instructions to determine a location of the user;
program instructions to determine the location of the user is not following a transaction path, wherein the transaction path is a path from a location of the indication corresponding to the transaction to execute to the mobile payment method; and
program instructions to notify the user of that the location of the user is not following the transaction path.

11. The computer program product of claim 10, further comprising:
based on determining the location of the user is not following a transaction path, program instructions to request approval from a user for an updated transaction; and
program instructions to receive approval from the user.

12. The computer program product of claim 8, wherein the medium-range wireless communication protocol comprises one or more of: wi-fi and a low energy wireless protocol.

13. The computer program product of claim 8, wherein receiving approval from the user comprises authentication by the user.

14. The computer program product of claim 8, wherein the short-range wireless communication protocol is a near field communication protocol.

15. A computer system for transaction authentication, the computer system comprising:
one or more processors, one or more computer-readable memories, one or more computer-readable tangible storage devices, and program instructions stored on at least one of the one or more storage devices for execution by at least one of the one or more processors via at least one of the one or more memories, the program instructions comprising:
program instructions to receive an indication corresponding to a transaction to execute, wherein the indication is received from a network server via a wireless access point using a medium-range wireless communication protocol;
based on receiving the indication, program instructions to request an indication of approval to initiate the transaction to execute from a user using a graphical interface element on a display;
based on receiving the indication of approval to execute the transaction to execute, program instructions to authorize the transaction to execute for a period of time;
program instructions to detect within a period of time a mobile payment method associated with the transaction to execute, wherein the mobile payment method is detected from a point of sale device using a short-range wireless communication protocol; and
based on detecting the mobile payment method associated with the transaction to execute, program instructions to initiate the transaction.

16. The computer system of claim 15, further comprising:
based on determining that the period of time has expired, program instructions to request a renewal of the transaction to execute from the user; and
based on receiving the renewal of the transaction to execute from the user, program instructions to extend the period of time.

17. The computer system of claim 15, further comprising:
program instructions to determine a location of the user;
program instructions to determine the location of the user is not following a transaction path, wherein the transaction path is a path from a location of the indication corresponding to the transaction to execute to the mobile payment method; and
program instructions to notify the user of that the location of the user is not following the transaction path.

18. The computer system of claim 17, further comprising:
based on determining the location of the user is not following a transaction path, program instructions to request approval from a user for an updated transaction; and
program instructions to receive approval from the user.

19. The computer system of claim 15, wherein the medium-range wireless communication protocol comprises one or more of: wi-fi and a low energy wireless protocol.

20. The computer system of claim 15, wherein the short-range wireless communication protocol is a near field communication protocol.
